(19) United States
(12) Patent Application Publication
(10) Pub. No.: US 2020/0344545 A1
(43) Pub. Date: Oct. 29, 2020

(54) AUDIO SIGNAL ADJUSTMENT

(71) Applicant: Cisco Technology, Inc., San Jose, CA (US)

(72) Inventors: Knut Inge Hvidsten, Oslo (NO); Espen Moberg, Nesoya (NO)

(21) Appl. No.: 16/394,328

(22) Filed: Apr. 25, 2019

(51) Int. Cl. H04R 3/00; G10L 21/0208; G10L 21/0272

(52) U.S. Cl. CPC H04R 3/005; G10L 2021/02165; G10L 21/0272; G10L 21/0208

(57) ABSTRACT

In one example, a headset may obtain, from a first microphone that is configured at a first location relative to an audio source, a first audio signal having a first audio level. The headset may further obtain, from a second microphone that is configured at a second location relative to the audio source, a second audio signal having a second audio level. The second location may be a greater distance from the audio source than the first location. The headset may determine a target audio level based on the second audio level. The headset may adjust the first audio signal to the target audio level to produce an adjusted first audio signal, and output the adjusted first audio signal.

### TECHNICAL FIELD

The present disclosure relates to audio signal processing.

### BACKGROUND

Local participants in conferencing sessions (e.g., online or web-based meetings, telephone calls, etc.) often use headsets with an integrated speaker and/or microphone to communicate with remote meeting participants. Some headsets have a microphone in a boom which is located a small distance from the mouth of the participant relative to other sound sources (e.g., room reflections, interfering speech, noise sources, etc.). These microphones can detect non-reverberant speech with a high Signal-to-Noise Ratio (SNR) because audio sources close to the microphone will typically dominate. In particular, because the microphone is within the so-called “critical distance” of the room, the direct sound from the mouth of the participant will dominate over reverberant sound.

### BRIEF DESCRIPTION OF THE DRAWINGS

FIG. 1 illustrates a block diagram of a system configured to adjust an audio signal to a target audio level, according to an example embodiment.

FIG. 2 illustrates a block diagram of a system configured for microphone calibration, according to an example embodiment.

FIG. 3A illustrates a block diagram of another system configured to adjust an audio signal to a target audio level, according to an example embodiment.

FIG. 3B illustrates a plot of audio signals from the system of FIG. 3A over time, according to an example embodiment.

FIG. 4A illustrates a block diagram of yet another system configured to adjust an audio signal to a target audio level, according to an example embodiment.

FIG. 4B illustrates a plot of audio signal components and gain from the system of FIG. 4A over time, according to an example embodiment.

FIG. 5 illustrates a flowchart of a method for adjusting an audio signal to a target audio level, according to an example embodiment.

### DESCRIPTION OF EXAMPLE EMBODIMENTS

### Overview

In one example embodiment, a headset may obtain, from a first microphone that is configured at a first location relative to an audio source, a first audio signal having a first audio level. The headset may further obtain, from a second microphone that is configured at a second location relative to the audio source, a second audio signal having a second audio level. The second location may be a greater distance from the audio source than the first location. The headset may determine a target audio level based on the second audio level. The headset may adjust the first audio signal to the target audio level to produce an adjusted first audio signal, and output the adjusted first audio signal.

### Example Embodiments

A microphone may be in the near field or in the far field. Microphones in the far field (e.g., greater than 0.3 meters) follow the inverse square law, according to which there is a general reduction in sound level as a function of distance from the sound source. At small distances, small absolute changes in distance cause large relative changes in distance, and therefore large changes in the Sound Pressure Level (SPL). For example, if the distance between the mouth and the microphone is doubled, the SPL is reduced (e.g., by 6 dB). If the distance is halved, the SPL is increased (e.g., by 6 dB). If the distance is unknown, the SPL and corresponding electronic audio levels cannot be predicted. Microphones in the far field can be modeled according to simple free-space behavior, assuming that the mouth is an acoustically small source at the frequencies and distances of interest.

The transition from near field to far field occurs at some wavelength or in proportion to the size of the mouth of the participant, whichever is greater. For example, a microphone that detects typical speech (e.g., 100-8000 Hz) from a typical mouth size of 0.1 m is in the near field. Meanwhile, a free space microphone operating at 0.3 m would be expected to operate close to the transition between the near field and the far field, with low frequencies within the near field and high frequencies within the far field for typical speech spectra.

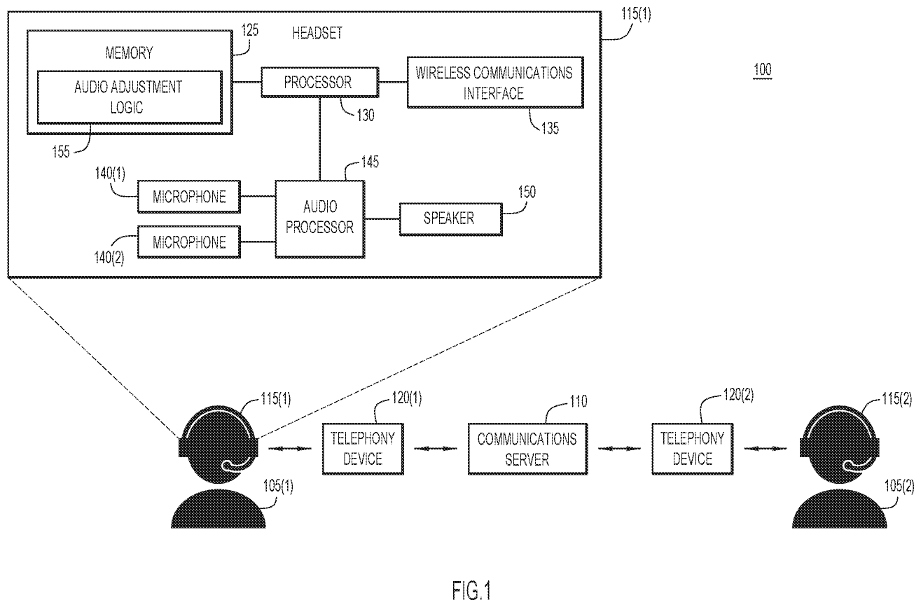

With reference made to FIG. 1, shown is an example system 100 for adjusting an audio signal to a target audio level. In the scenario depicted by FIG. 1, meeting attendees 105(1) and 105(2) are attending an online/remote meeting (e.g., audio call) or conference session. System 100 includes communications server 110, headsets 115(1) and 115(2), and telephony devices 120(1) and 120(2). Communications server 110 is configured to host or otherwise facilitate the meeting. Meeting attendee 105(1) is wearing headset 115(1) and meeting attendee 105(2) is wearing headset 115(2). Headsets 115(1) and 115(2) enable meeting attendees 105(1) and 105(2) to communicate with (e.g., speak and/or listen to) each other in the meeting. Headsets 115(1) and 115(2) may pair to telephony devices 120(1) and 120(2) to enable communication with communications server 110. Examples of telephony devices 120(1) and 120(2) may include desk phones, laptops, conference endpoints, etc.

FIG. 1 also shows a block diagram of headset 115(1). Headset 115(1) includes memory 125, processor 130, and wireless communications interface 135. Memory 125 may be read only memory (ROM), random access memory (RAM), magnetic disk storage media devices, optical storage media devices, flash memory devices, electrical, optical, or other physical/tangible memory storage devices. Thus, in general, memory 125 may comprise one or more tangible (non-transitory) computer readable storage media (e.g., a memory device) encoded with software comprising computer executable instructions and when the software is executed (by the processor 130) it is operable to perform the operations described herein.

Wireless communications interface 135 may be configured to operate in accordance with the Bluetooth® short-range wireless communication technology or any other suitable technology now known or hereinafter developed. Wireless communications interface 135 may enable communication with telephony device 120(1). Although wireless communications interface 135 is shown in FIG. 1, it will be appreciated that other communication interfaces may be utilized additionally/alternatively. For example, in another embodiment, headset 115(1) may utilize a wired communication interface to connect to telephony device 120(1).

Headset 115(1) also includes microphones 140(1) and 140(2), audio processor 145, and speaker 150. Audio processor 145 may include one or more integrated circuits that convert audio detected by microphones 140(1) and 140(2) to digital signals that are supplied (e.g., as analog signals) to the processor 130 for wireless transmission via wireless communications interface 135 (e.g., when meeting attendee 105(1) speaks). Thus, processor 130 is coupled to receive signals derived from outputs of microphones 140(1) and 140(2) via audio processor 145. Audio processor 145 may also convert received audio (via wireless communication interface 135) to analog signals to drive speaker 150 (e.g., when meeting attendee 105(2) speaks). Headset 115(2) may include similar functional components as those shown with reference to headset 115(1). In one example, headset 115(2) is the same type/model of headset as headset 115(1).

Microphone 140(1) may be configured to capture anechoic, low-noise speech at somewhat arbitrary absolute signal levels and provide a high-quality capture of speech (e.g., resembling that of far field capture in a low-noise, anechoic chamber). Microphone 140(2) may be configured to capture a lower-quality signal (e.g., higher noise and reverberation relative to dry speech, high-frequency spectrally modified speech, etc.) that has a predictable absolute acoustic sensitivity due to the approximately constant relative distance to the mouth of meeting attendee 105(1).

In one example, microphone 140(1) may be configured at a first location relative to an audio source (e.g., the mouth of meeting attendee 105(1)), and microphone 140(2) may be configured at a second location relative to the audio source. The second location may be a greater distance from the audio source than the first location. For example, headset 115(1) may include a boom configured to house microphone 140(1) and an earpiece configured to house microphone 140(2). In this example, the boom may be closer to the mouth of meeting attendee 105(1) than the earpiece. Alternatively, microphone 140(2) may be configured in headset 115(1) near the top of the head of meeting attendee 105(1), or along a known-length cable dangling from headset 115(1).

Thus, microphone 140(1) may be in the near field, and microphone 140(2) may be in the far field (or near the transition between the near field and the far field). Unlike the far field, the near field does not follow the inverse square law. Although there is an overall trend of decreasing SPL with decreasing distance in the near field, specific SPLs at microphone 140(1) and the corresponding microphone in headset 115(2) are quite unpredictable as a function of microphone distance.

Conventionally, even a minimal difference in microphone-to-mouth distances (e.g., a few centimeters) between headsets 115(1) and 115(2) would cause headsets 115(1) and 115(2) to output essentially unpredictable relative audio levels. This is problematic because telecommunications standards typically mandate specific speech levels for digital communications (e.g., nominally 27 dB below the digital clipping, or Full Scale, threshold). As such, conventionally, mixing/switching between headsets 115(1) and 115(2) would cause discomfort to meeting attendees 105(1) and 105(2).

Traditional approaches to equalizing the audio levels between meeting attendees 105(1) and 105(2) would employ basic automatic gain control. Basic automatic gain control involves increasing the audio level(s) of meeting attendees 105(1) and/or 105(2) if too low, and decreasing the audio level(s) if too high. Basic automatic gain control would have the effect of flattening out transients in speech of meeting attendees 105(1) and/or 105(2). For example, if meeting attendee 105(1) naturally speaks with varying levels of loudness or softness, automatic gain control would disturb the natural temporal envelope (variability) in speech. Furthermore, if microphone 140(1) picks up background noise while meeting attendee 105(1) is silent, automatic gain control would boost the background noise. For high-quality conferencing or Virtual Reality (VR)/Augmented Reality (AR) applications, where supporting the illusion of natural/traditional communication is critical to user experience, such flaws are highly detrimental.

Accordingly, audio adjustment logic 155 is provided in headset 115(1) to intelligently adjust an audio signal from microphone 140(1). In particular, processor 130 obtains a first audio signal having a first audio level from microphone 140(1), and obtains a second audio signal having a second audio level from microphone 140(2). Processor 130 determines a target audio level based on the second audio level, and adjusts the first audio signal to the target audio level to produce an adjusted first audio signal. Processor 130 may output the adjusted first audio signal, for example to telephony device 120(1) en route to headset 115(2). This mechanism overcomes downsides to traditional approaches, e.g., by avoiding flattening of speech transients and boosting of unwanted background noise.

Headset 115(1) may adjust the first audio signal to the target audio level by calculating a difference between the target audio level and the first audio level, and increasing or decreasing the first audio level by the difference between the target audio level and the first audio level. For example, the target audio level may be 84 dB, but the first audio level of microphone 140(1) may only be 80 dB due to the positioning of microphone 140(1) from the mouth of meeting attendee 105(1). In this example, headset 115(1) may increase the first audio signal of microphone 140(1) by 4 dB such that the first audio level now matches the target audio level of 84 dB.

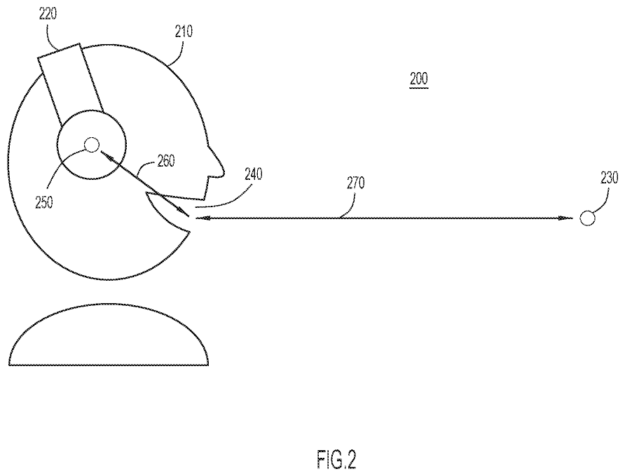

Headset 115(1) may determine the target audio level (e.g., 84 dB) by adding/subtracting a predetermined value to/from the second audio level. For example, the audio level of microphone 140(2) may be 72 dB, and the predetermined value may be 12 dB. Thus, headset 115(1) may add the audio level of microphone 140(2) (here, 72 dB) to the predetermined value (here, 12 dB) to arrive at the target audio level of 84 dB. The predetermined value is further described in connection with FIG. 2 below.

In one example, headset 115(1) may determine that the second audio level is greater than or equal to the first audio level less a predetermined amount and, in response, cease adjusting the first audio signal to the target audio level. The predetermined amount may be an empirically-determined non-negative constant. When the second audio level is less than the first audio level less the predetermined amount, the first audio level of microphone 140(1) is significantly stronger than the second audio level of microphone 140(2). However, if the second audio level is greater than or equal to the first audio level less the predetermined amount, the first and/or second audio signals are likely dominated by some external interfering noise, and as such there may not be sufficient confidence to adjust the first audio signal of microphone 140(1). In this case, headset 115(1) may freeze the first audio signal at a previously determined audio level or fall back to automatic gain control.

In another example, headset 115(1) may determine that the first audio level is less than a predetermined level and, in response, cease adjusting the first audio signal to the target audio level. The predetermined level may be an absolute SPL value. If the first audio level is less than the predetermined level, the first audio level may be significantly below that associated with normal speech audio levels. Thus, in this case, headset 115(1) may freeze the first audio signal at a previously determined audio level or fall back to automatic gain control.

Microphone 140(1) may be an omnidirectional microphone. Constructing microphone 140(1) as an omnidirectional microphone may reduce cost and complexity relative to a directional microphone. Microphone 140(1) may also be better suited for near field audio capture as an omnidirectional microphone. For example, microphone 140(1) may experience little to no proximity effect (bass boost) as an omnidirectional microphone. Furthermore, constructing microphone 140(1) as an omnidirectional microphone may reduce pickup of structural vibrations of headset 115(1).

Headset 115(1) may also perform further processing of the audio signals from microphones 140(1) and 140(2). In one example, headset 115(1) may use a covariance to model the power and linear dependency of the audio signal between microphones 140(1) and 140(2). Microphone 140(1) may be more energetic than microphone 140(2), and there may be a strong linear dependency in the normal (sunny side) operating regime. In another example, headset 115(1) may use a (short) adaptive filter such as the Normalized Least Mean Square (NLMS) to model the acoustic path differences between microphones 140(1) and 140(2). For instance, the dominant acoustic path (maximum magnitude of NLMS filter taps) to microphone 140(1) may lead microphone 140(2) in time by the equivalent of 0.1-0.2 meters in the normal (sunny side) operating regime.

Headset 115(1) may also perform pre-processing of the audio signals from microphones 140(1) and 140(2). In one example, headset 115(1) may cross-correlate the audio signals from microphones 140(1) and 140(2) in order to reduce the influence of noise. In another example, headset 115(1) may perform bandpass filtering of audio signal(s) from microphones 140(1) and/or 140(2) in order to reduce the (dominantly high-frequency propagation) influence of the head of meeting attendee 105(1) and to focus on the most energetic speech band (e.g., dominantly low-frequency contribution of 1/f room acoustic noise, such as 100-2000 Hz). Because meeting attendee 105(1) is expected to seldom change the location of microphone 140(2), headset 115(1) may perform heavy smoothing of the estimates/gain (e.g., on the order of tens of seconds), thereby reducing “nervous” artifacts and averaging out some spectral variability in speech.

FIG. 2 illustrates an example system 200 configured for microphone calibration. Continued reference is made to FIG. 1 for the purposes of the description of FIG. 2. System 200 includes head 210, headset 220, and reference microphone 230, which in one example are located in an anechoic chamber. Head 210 may be the head of a human user or an artificial head. Head 210 includes audio source 240. If head 210 is the head of a user, audio source 240 may be a mouth of the user. If head 210 is an artificial head, audio source 240 may be configured to generate sound that is spatially and spectrally similar to speech.

Headset 220 is placed on head 210 and may include an earpiece configured to house or support microphone 250. Headset 220 may be the same type/model of headset as headset 115(1), and microphone 250 may be the same type/model of microphone as microphone 140(2). Microphone 250 may be configured at some location relative to audio source 240, as represented by arrow 260. Location represented by arrow 260 may be similar to a location of microphone 140(2) relative to the mouth of meeting attendee 105(1). Furthermore, reference microphone 230 may be the same type/model of microphone as microphone 250. Reference microphone 230 may be configured at some location relative to audio source 240, as represented by arrow 270.

As discussed above in connection with FIG. 1, headset 115(1) may determine the target audio level by adding/subtracting a predetermined value to/from the audio level of microphone 140(2). The predetermined value may be based on a predetermined difference between the audio level of an audio signal detected by microphone 140(2) and an audio level of an audio signal that would be detected by microphone 140(2) at location 270.

For example, microphone 250 may detect an audio level of 62 dB from audio source 240 while reference microphone 230 detects an audio level of 79 dB. Thus, the predetermined difference is 17 dB, which is the difference between the audio level detected by reference microphone 230 (here, 79 dB) and the audio level detected by microphone 250 (here, 62 dB). Once the predetermine difference has been determined, headset 115(1) may be programmed with the predetermined difference. For example, a plurality of headsets including headsets 115(1) and 115(2) may be programmed with the predetermined difference during manufacturing. The plurality of headsets may be of the same type/model as headset 220, and may include respective microphones of the same type/model as microphone 250 and reference microphone 230.

Because microphone 250, reference microphone 230, and microphone 140(2) are each the same type/model of microphone, it may be inferred that when microphone 140(2) detects an audio level of 62 dB from the mouth of meeting attendee 105(1), microphone 140(2) would detect an audio level of 79 dB at location 270. The predetermined difference may be subject to tolerances, model inaccuracy, and variations in speech produced by meeting attendee 105(1) and speech produced by head 210. In another example, the predetermined difference may indicate, for instance, that 27 dB below the digital clipping threshold corresponds to 95 dB at one meter in an anechoic environment.

Location 270 may be any suitable location relative to audio source 240. In one example, location 270 may be similar to an expected location of a human in an in-person conversation. Thus, for example, location 270 may be one meter horizontally from audio source 240 because in real conversations people may be expected to be located about one meter horizontally apart. Practically, this enables meeting attendee 105(2) to render meeting attendee 105(1) at physically informed levels based on a number of factors. These factors may include, for example, one or more of: assumption of far field distances; playback and other acoustics of the local physical environment (e.g., room) of meeting attendee 105(2); distance to the meeting attendee 105(2); and location/distance at which meeting attendee 105(1) should be rendered (e.g., as guided by a visual rendering size). Thus, the choice of reference levels across the network is part pragmatic and part political.

The calibration described in FIG. 2 may exploit the direct relationship that may exist between a digital domain peak value of 0 dB relative to digital clipping (full scale) at a given frequency (e.g., 1 kHz) and an equivalent free-space SPL. For a commercial product, this is likely to hold true within some tolerance (e.g., plus-or-minus 2 dB), mainly due to variation in transducers and product assembly. Microphone 140(1) may be similarly absolutely calibrated by relating some free-field SPL to microphone voltage or Analog-to-Digital Converter (ADC) numerical value.

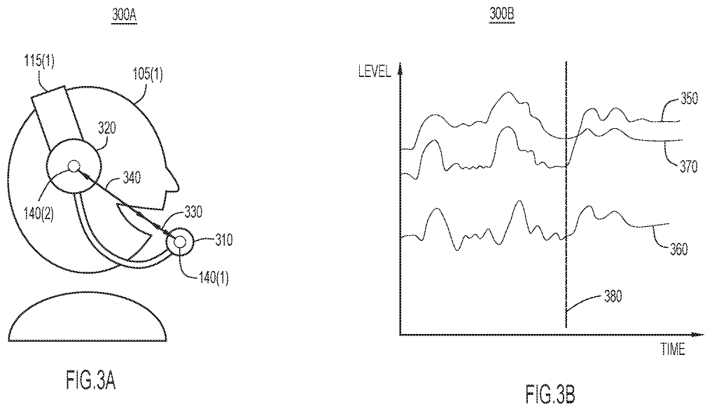

FIG. 3A illustrates an example system 300A configured to adjust an audio signal to a target audio level. Continued reference is made to FIG. 1 for the purposes of description of FIG. 3A. In the scenario depicted by FIG. 3A, meeting attendee 105(1) is attending an online/remote meeting or teleconference (audio only or audio and video) session (e.g., with meeting attendee 105(2) on the far end). System 300A includes headset 115(1), which includes a boom 310 configured to house microphone 140(1) and an earpiece 320 configured to house microphone 140(2). Microphone 140(1) is configured at a first location relative to an audio source (e.g., the mouth of meeting attendee 105(1)), as represented by arrow 330. Microphone 140(2) is configured at a second location relative to the mouth of meeting attendee 105(1), as represented by arrow 340. Location 340 is a greater distance from the audio source than location 330.

FIG. 3B illustrates an example plot 300B of audio signals from system 300A over time. Plot 300B illustrates audio signal 350 generated by microphone 140(1), audio signal 360 generated by microphone 140(2), and adjusted audio signal 370. Headset 115(1) may produce adjusted audio signal 370 by adjusting audio signal 350 to the target audio level. For example, meeting attendee 105(1) may produce speech (with transients) for the duration of time shown in plot 300B. At time 380, meeting attendee 105(1) moves boom 310 closer to the mouth of meeting attendee 105(1). This causes an increase in the audio level of audio signal 350, but the audio level of audio signal 360 is virtually unaffected. Because headset 115(1) determines the target audio level based on the audio level of audio signal 360, headset 115(1) reduces the gain on audio signal 360. Thus, adjusted audio level 370 remains stable, thereby maintaining the illusion of the physical presence of meeting attendee 105(1) for meeting attendee 105(2).

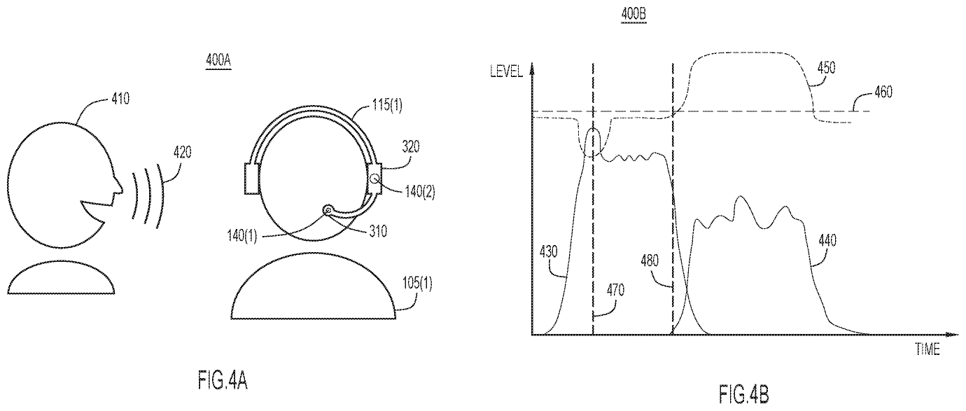

FIG. 4A illustrates an example system 400A configured to adjust an audio signal to a target audio level. Continued reference is made to FIGS. 1 and 3 for the purposes of describing FIG. 4A. In the scenario depicted by FIG. 4A, meeting attendee 105(1) is attending an online/remote meeting or teleconference session (e.g., with meeting attendee 105(2) on the far end). System 400A includes headset 115(1), which includes boom 310 configured to house microphone 140(1) and earpiece 320 configured to house microphone 140(2). A background noise source 410 (e.g., a person) is present in the local environment of meeting attendee 105(1). Background noise source 410 produces noise 420 (e.g., background speech) which can affect the audio signal produced by microphone 140(1).

FIG. 4B illustrates an example plot 400B of audio signal components and gain from system 400A over time. Plot 400B illustrates components 430 and 440 of the audio signal generated by microphone 140(1). Component 430 is attributable to speech from meeting attendee 105(1) and component 440 is attributable to background noise source 410. Plot 400B further illustrates gains 450 and 460. Gain 450 is the gain that would be applied by basic automatic gain control techniques to the audio signal generated by microphone 140(1). Gain 460 is the gain applied to the audio signal generated by microphone 140(1) in accordance with the techniques described herein.

Initially, meeting attendee 105(1) is producing speech, as indicated by component 430. Background noise source 410 is not yet producing noise 420. At time 470, meeting attendee 105(1) introduces a large transient to the speech (e.g., an exclamation or other emphasis). As shown, gain 450 would decrease, thereby flattening the transient. By contrast, gain 460 does not change in response to the transient. Thus, unlike traditional automatic gain control, the present techniques preserve transients in speech.

Subsequently, at time 480, background noise source 410 begins producing noise 420, as indicated by component 440. The audio level of component 440 may depend on the distance between background noise source 410 and microphone 140(1) (e.g., two meters) as well as the location of background noise source 410 relative to the directivity of microphone 140(1), if any. Meeting attendee 105(1) also stops talking at time 480, as indicated by component 430. As shown, gain 450 would increase, thereby boosting noise 420, because basic automatic gain control cannot robustly distinguish between speech from meeting attendee 105(1) and background noise source 410. By contrast, gain 460 does not change in response to noise 420. The target audio level is based on the audio level of microphone 140(2), which is relatively unaffected by noise 420. As such, unlike basic automatic gain control, the present techniques preserve transients in speech and avoid boosting noise 420.

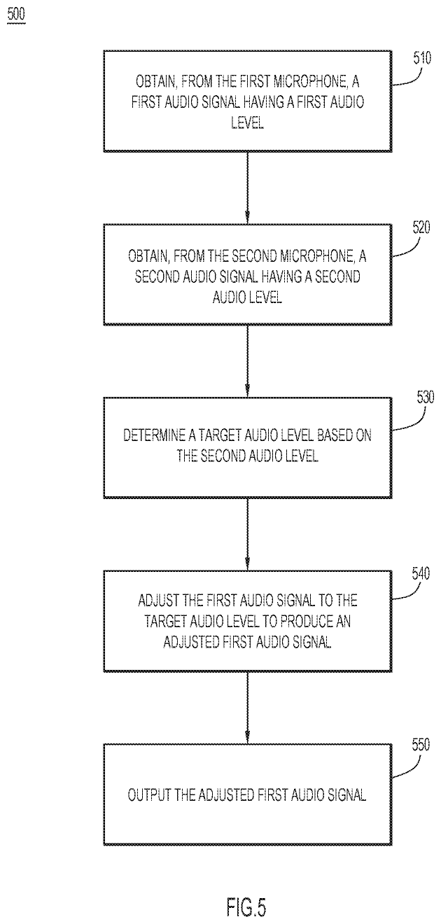

FIG. 5 is a flowchart of a method 500 for adjusting an audio signal to a target audio signal employing the techniques presented herein. Method 500 may be performed by a headset (e.g., headset 115(1)). The headset may include a first microphone that is configured at a first location relative to an audio source (e.g., microphone 140(1)) and a second microphone that is configured at a second location relative to the audio source (e.g., microphone 140(2)). The second location may be a greater distance from the audio source than the first location.

At 510, the headset obtains, from the first microphone, a first audio signal having a first audio level. At 520, the headset obtains, from the second microphone, a second audio signal having a second audio level. At 530, the headset determines a target audio level based on the second audio level. At 540, the headset adjusts the first audio signal to the target audio level to produce an adjusted first audio signal. At 550, the headset outputs the adjusted first audio signal.

Thus, a dual-microphone solution is presented for headset boom microphone gain control, exploiting one close microphone for high quality capture (e.g., microphone 140(1)) and another semi-close microphone for its stable speech levels (e.g., microphone 140(2)). The close microphone may be calibrated in a similar manner to the semi-close microphone, although this may not be necessary to perform the operations described herein. The dual-microphone setup may provide natural-sounding speech capture at predetermined reference levels that is free of dynamic processing artifacts which are otherwise commonly associated with basic automatic gain control. In particular, these techniques enable production of a digital output speech level consistent with levels at some distance (e.g., one meter plus-or-minus some agreed-upon offset) while improving upon problematic cases such as (1) interfering noise/speech, and (2) the user fiddling with the boom, which introduces high-level noise to the close microphone but not the semi-close microphone.

Any suitable device(s) configured to store audio adjustment logic 155 (FIG. 1) may perform the operations described herein. In one example, any applicable headset may perform one or more operations described herein. The headset may be equipped for digital signal processing, and may be a Universal Serial Bus (USB) audio headset or a wireless headset. Furthermore, the headset may be a near-end headset (e.g., headset 115(1)) or a far-end headset (e.g., headset 115(2)), as depicted in FIG. 1. If audio adjustment logic 155 is configured on a headset, one or more audio streams may contain unprocessed audio (e.g., a linear time-invariant audio capture to benefit subsequent processing), and the gain may be transmitted as metadata at a relatively low sampling rate (e.g., 100 samples/second). In another example, audio adjustment logic 155 may be stored on an endpoint device (e.g., a video conferencing endpoint device) interfaced with a purely analog mechanic/acoustic/electric device. Alternatively, one or more servers (e.g., communications server 110) may perform the operations described herein.

The programs described herein are identified based upon the application for which they are implemented in a specific embodiment. However, it should be appreciated that any particular program nomenclature herein is used merely for convenience, and thus the embodiments should not be limited to use solely in any specific application identified and/or implied by such nomenclature.

Data relating to operations described herein may be stored within any conventional or other data structures (e.g., files, arrays, lists, stacks, queues, records, etc.) and may be stored in any desired storage unit (e.g., database, data or other repositories, queue, etc.). The data transmitted between entities may include any desired format and arrangement, and may include any quantity of any types of fields of any size to store the data. The definition and data model for any datasets may indicate the overall structure in any desired fashion (e.g., computer-related languages, graphical representation, listing, etc.).

The present embodiments may employ any number of any type of user interface (e.g., Graphical User Interface (GUI), command-line, prompt, etc.) for obtaining or providing information (e.g., data relating to scraping network sites), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The environment of the present embodiments may include any number of computer or other processing systems (e.g., client or end-user systems, server systems, etc.) and databases or other repositories arranged in any desired fashion, where the present embodiments may be applied to any desired type of computing environment (e.g., cloud computing, client-server, network computing, mainframe, stand-alone systems, etc.). The computer or other processing systems employed by the present embodiments may be implemented by any number of any personal or other type of computer or processing system (e.g., desktop, laptop, PDA, mobile devices, etc.), and may include any commercially available operating system and any combination of commercially available and custom software (e.g., machine learning software, etc.). These systems may include any types of monitors and input devices (e.g., keyboard, mouse, voice recognition, etc.) to enter and/or view information.

It is to be understood that the software of the present embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present embodiments may be distributed in any manner among the various end-user/client and server systems, and/or any other intermediary processing devices. The software and/or algorithms described above and illustrated in the flow charts may be modified in any manner that accomplishes the functions described herein. In addition, the functions in the flow charts or description may be performed in any order that accomplishes a desired operation.

The software of the present embodiments may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., data relating to contact center interaction routing). The database system may be implemented by any number of any conventional or other databases, data stores or storage structures (e.g., files, databases, data structures, data or other repositories, etc.) to store information (e.g., data relating to contact center interaction routing). The database system may be included within or coupled to the server and/or client systems. The database systems and/or storage structures may be remote from or local to the computer or other processing systems, and may store any desired data (e.g., data relating to contact center interaction routing).

The present embodiments may employ any number of any type of user interface (e.g., Graphical User Interface (GUI), command-line, prompt, etc.) for obtaining or providing information (e.g., data relating to providing enhanced delivery options), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The embodiments presented may be in various forms, such as a system, a method, and/or a computer program product at any possible technical detail level of integration. The computer program product may include a computer readable storage medium (or media) having computer readable program instructions thereon for causing a processor to carry out aspects of presented herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects presented herein.

Aspects of the present embodiments are described herein with reference to flowchart illustrations and/or block diagrams of methods, apparatus (systems), and computer program products according to the embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In one form, an apparatus is provided. The apparatus comprises: a first microphone that is configured at a first location relative to an audio source; a second microphone that is configured at a second location relative to the audio source, wherein the second location is a greater distance from the audio source than the first location; and one or more processors coupled to receive signals derived from outputs of the first microphone and the second microphone, wherein the one or more processors are configured to: obtain, from the first microphone, a first audio signal having a first audio level; obtain, from the second microphone, a second audio signal having a second audio level; determine a target audio level based on the second audio level; adjust the first audio signal to the target audio level to produce an adjusted first audio signal; and output the adjusted first audio signal.

In one example, the one or more processors are configured to adjust the first audio signal to the target audio level by: calculating a difference between the target audio level and the first audio level; and increasing or decreasing the first audio level by the difference between the target audio level and the first audio level.

In one example, the one or more processors are configured to determine the target audio level by adding a predetermined value to the second audio level or subtracting the predetermined value from the second audio level. In a further example, the predetermined value is based on a predetermined difference between the second audio level and a third audio level of a third audio signal that would be detected by the second microphone at a third location relative to the audio source.

In one example, the one or more processors are further configured to: determine that the second audio level is greater than or equal to the first audio level less a predetermined amount; and in response to determining that the second audio level is greater than or equal to the first audio level less the predetermined amount, cease adjusting the first audio signal to the target audio level. In another example, the one or more processors are further configured to: determine that the first audio level is less than a predetermined level; and in response to determining that the first audio level less than the predetermined level, cease adjusting the first audio signal to the target audio level.

In one example, the apparatus further comprises: a boom configured to house the first microphone; and an earpiece configured to house the second microphone. In another example, the first microphone is an omnidirectional microphone.

In another form, a method is provided. The method comprises: obtaining, from a first microphone that is configured at a first location relative to an audio source, a first audio signal having a first audio level; obtaining, from a second microphone that is configured at a second location relative to the audio source, a second audio signal having a second audio level, wherein the second location is a greater distance from the audio source than the first location; determining a target audio level based on the second audio level; adjusting the first audio signal to the target audio level to produce an adjusted first audio signal; and outputting the adjusted first audio signal.

In another form, one or more non-transitory computer readable storage media are provided. The non-transitory computer readable storage media are encoded with instructions that, when executed by one or more processors coupled to receive signals derived from outputs of a first microphone that is configured at a first location relative to an audio source and a second microphone that is configured at a second location relative to the audio source, wherein the second location is a greater distance from the audio source than the first location, cause the one or more processors to: obtain, from the first microphone, a first audio signal having a first audio level; obtain, from the second microphone, a second audio signal having a second audio level; determine a target audio level based on the second audio level; adjust the first audio signal to the target audio level to produce an adjusted first audio signal; and output the adjusted first audio signal.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. An apparatus comprising:
a first microphone that is configured at a first location relative to an audio source;
a second microphone that is configured at a second location relative to the audio source, wherein the second location is a greater distance from the audio source than the first location; and
one or more processors coupled to receive signals derived from outputs of the first microphone and the second microphone, wherein the one or more processors are configured to:
obtain, from the first microphone, a first audio signal having a first audio level;
obtain, from the second microphone, a second audio signal having a second audio level;
determine a target audio level based on the second audio level;
adjust the first audio signal to the target audio level to produce an adjusted first audio signal; and
output the adjusted first audio signal.

2. The apparatus of claim 1, wherein the one or more processors are configured to adjust the first audio signal to the target audio level by:
calculating a difference between the target audio level and the first audio level; and
increasing or decreasing the first audio level by the difference between the target audio level and the first audio level.

3. The apparatus of claim 1, wherein the one or more processors are configured to determine the target audio level by adding a predetermined value to the second audio level or subtracting the predetermined value from the second audio level.

4. The apparatus of claim 3, wherein the predetermined value is based on a predetermined difference between the second audio level and a third audio level of a third audio signal that would be detected by the second microphone at a third location relative to the audio source.

5. The apparatus of claim 1, wherein the one or more processors are further configured to:
determine that the second audio level is greater than or equal to the first audio level less a predetermined amount; and
in response to determining that the second audio level is greater than or equal to the first audio level less the predetermined amount, cease adjusting the first audio signal to the target audio level.

6. The apparatus of claim 1, wherein the one or more processors are further configured to:
determine that the first audio level is less than a predetermined level; and
in response to determining that the first audio level is less than the predetermined level, cease adjusting the first audio signal to the target audio level.

7. The apparatus of claim 1, further comprising:
a boom configured to house the first microphone; and
an earpiece configured to house the second microphone.

8. The apparatus of claim 1, wherein the first microphone is an omnidirectional microphone.

9. A method comprising:
obtaining, from a first microphone that is configured at a first location relative to an audio source, a first audio signal having a first audio level;
obtaining, from a second microphone that is configured at a second location relative to the audio source, a second audio signal having a second audio level, wherein the second location is a greater distance from the audio source than the first location;
determining a target audio level based on the second audio level;
adjusting the first audio signal to the target audio level to produce an adjusted first audio signal; and
outputting the adjusted first audio signal.

10. The method of claim 9, wherein adjusting the first audio signal to the target audio level includes:
calculating a difference between the target audio level and the first audio level; and
increasing or decreasing the first audio level by the difference between the target audio level and the first audio level.

11. The method of claim 9, wherein determine the target audio level includes:
adding a predetermined value to the second audio level or subtracting the predetermined value from the second audio level.

12. The method of claim 11, wherein the predetermined value is based on a predetermined difference between the second audio level and a third audio level of a third audio signal that would be detected by the second microphone at a third location relative to the audio source.

13. The method of claim 9, further comprising:
determining that the second audio level is greater than or equal to the first audio level less a predetermined amount; and
in response to determining that the second audio level is greater than or equal to the first audio level less the predetermined amount, ceasing adjusting the first audio signal to the target audio level.

14. The method of claim 9, further comprising:
determining that the first audio level is less than a predetermined level; and
in response to determining that the first audio level is less than the predetermined level, ceasing adjusting the first audio signal to the target audio level.

15. One or more non-transitory computer readable storage media encoded with instructions that, when executed by one or more processors coupled to receive signals derived from outputs of a first microphone that is configured at a first location relative to an audio source and a second microphone that is configured at a second location relative to the audio source, wherein the second location is a greater distance from the audio source than the first location, cause the one or more processors to:
obtain, from the first microphone, a first audio signal having a first audio level;
obtain, from the second microphone, a second audio signal having a second audio level;
determine a target audio level based on the second audio level;
adjust the first audio signal to the target audio level to produce an adjusted first audio signal; and
output the adjusted first audio signal.

16. The one or more non-transitory computer readable storage media of claim 15, wherein the instructions further cause the one or more processors to adjust the first audio signal to the target audio level by:
calculating a difference between the target audio level and the first audio level; and
increasing or decreasing the first audio level by the difference between the target audio level and the first audio level.

17. The one or more non-transitory computer readable storage media of claim 15, wherein the instructions further cause the one or more processors to determine the target audio level by adding a predetermined value to the second audio level or subtracting the predetermined value from the second audio level.

18. The one or more non-transitory computer readable storage media of claim 17, wherein the predetermined value is based on a predetermined difference between the second audio level and a third audio level of a third audio signal that would be detected by the second microphone at a third location relative to the audio source.

19. The one or more non-transitory computer readable storage media of claim 15, wherein the instructions further cause the one or more processors to:
determine that the second audio level is greater than or equal to the first audio level less a predetermined amount; and
in response to determining that the second audio level is greater than or equal to the first audio level less the predetermined amount, cease adjusting the first audio signal to the target audio level.

20. The one or more non-transitory computer readable storage media of claim 15, wherein the instructions further cause the one or more processors to:
determine that the first audio level is less than a predetermined level; and
in response to determining that the first audio level is less than the predetermined level, cease adjusting the first audio signal to the target audio level.
